(19) United States
(12) Patent Application Publication
(10) Pub. No.: US 2026/0040216 A1
(43) Pub. Date: Feb. 5, 2026

(54) SYSTEMS FOR SUPPORTING MULTIPLE MR RAMP-UP TIMES FOR LOW POWER WAKE-UP SIGNAL MONITORING AND METHODS THEREOF

(71) Applicant: InterDigital Patent Holdings, Inc., Wilmington, DE (US)

(72) Inventors: Prasanna Herath, Laval, CA (US); Young Woo Kwak, Woodbury, NY (US); Moon IL Lee, Melville, NY (US); Nazli Khan Beigi, Longueuil, CA (US); Senay Negusse, Montreal, CA (US); Jongwoo Hong, New York, NY (US); Virgile Garcia, Antibes (FR)

(73) Assignee: InterDigital Patent Holdings, Inc., Wilmington, DE (US)

(21) Appl. No.: 18/794,789

(22) Filed: Aug. 5, 2024

(51) Int. Cl. H04W 52/02

(52) U.S. Cl. CPC H04W 52/0229

(57) ABSTRACT

Systems, methods, and apparatuses for multiple main radio receiver (MR) ramp-up times for low power wake-up signal (LP-WUS) monitoring by a wireless transmit/receive unit (WTRU) are provided. The WTRU determines and/or the WTRU receives configuration information indicative of a plurality of MR ramp-up times. The plurality of MR ramp-up times are based on a continuous time duration for which the WTRU monitors for the LP-WUS. The WTRU determines one or more physical downlink control channel (PDCCH) monitoring resources as a function of one or more MR ramp-up times of the plurality of MR ramp-up times. The WTRU determines whether to monitor the PDCCH outside a discontinuous reception (DRX) on duration timer and/or during the DRX on duration timer based on one or more conditions. The plurality of MR ramp-up times reduce latency caused by MR sleep states, increase efficiency of scheduling data transmission and/or reception, and reduce WTRU power consumption.

### BACKGROUND

In fifth generation (5G) wireless systems, user equipment implements different types of power saving modes by operating one or more radio receivers of the user equipment in various sleep modes. This facilitates reduction in power consumption, which would otherwise be incurred in continuous monitoring of one or more downlink signals and/or channels in an operational mode. However, a radio receiver is an electronic circuit that consumes a finite amount of time in switching between the various sleep modes and the operational mode, for instance, waking up from a sleep mode and/or entering into the sleep mode etc. As a result, conventional user equipment cannot efficiently switch between the modes for receiving the downlink signals and/or channels. Therefore, there is a need for a technique for monitoring a downlink signal while providing increased power saving while switching between the modes.

### SUMMARY

In an embodiment, a method performed by a wireless transmit/receive unit (WTRU) is provided. The method includes receiving configuration information from a base station. The configuration information includes one or more of: a first main radio receiver (MR) ramp-up time, a second MR ramp-up time, or a set of timers associated with monitoring a physical downlink control channel (PDCCH). The method includes starting a monitoring duration. The method includes activating a low power wake-up receiver (LP-WUR) and receiving a low-power wake-up signal (LP-WUS) using the LP-WUR. The method further includes, on a condition that the LP-WUS is received within the monitoring duration, monitoring for, after the first MR ramp-up time, a PDCCH transmission using the MR based on the set of timers. The method further includes, on a condition that the LP-WUS is received after the monitoring duration, monitoring for, after the second MR ramp-up time, the PDCCH transmission using the MR based on the set of timers.

In an embodiment, a WTRU comprising a memory, an MR, a transceiver, an LP-WUR, and a processor is provided. The transceiver is configured to receive, from a base station, configuration information including one or more of: a first MR ramp-up time, a second MR ramp-up time, or a set of timers associated with monitoring a physical downlink control channel (PDCCH). The processor is configured to start a monitoring duration. The processor is further configured to activate a low power wake-up receiver (LP-WUR) and receive a low-power wake-up signal (LP-WUS) using the LP-WUR. The processor is further configured to, on a condition that the LP-WUS is received within the monitoring duration, monitor for, after the first MR ramp-up time, a PDCCH transmission using the MR based on the set of timers. The processor is further configured to, on a condition that the LP-WUS is received after the monitoring duration, monitor for, after the second MR ramp-up time, the PDCCH transmission using the MR based on the set of timers.

In an embodiment, the first MR ramp-up time is associated with a first sleep state of the MR and the second MR ramp-up time is associated with a second sleep state of the MR.

In an embodiment, the MR switches from the first sleep state to the second sleep state when the monitoring duration is exceeded.

In an embodiment, the WTRU initializes the set of timers after the first MR ramp-up time when the LP-WUS is received within the monitoring duration.

In an embodiment, the WTRU initializes the set of timers after the second MR ramp-up time when the LP-WUS is received after the monitoring duration

In an embodiment, the configuration information further includes one or more of: an LP-WUS search space (SS) set, a first SS set associated with the first MR ramp-up time, or a second SS set associated with the second MR ramp-up time.

In an embodiment, the configuration information further includes one or more of: a discontinuous reception (DRX) configuration indicative of one or more DRX active periods and one or more DRX inactive periods.

In an embodiment, the WTRU monitors the PDCCH using the LP-WUS SS set upon receiving an indication via the LP-WUS.

In an embodiment, the WTRU monitors the PDCCH using the first SS set when the LP-WUS is received within the monitoring duration.

In an embodiment, the WTRU monitors the PDCCH using the second SS set when the LP-WUS is received after the monitoring duration.

In an embodiment, the WTRU measures a time elapsed after a start or a resumption of monitoring the LP-WUS. The WTRU compares the measured time with the monitoring duration. The WTRU determines that the LP-WUS is received within the monitoring duration if the measured time is less than the monitoring duration.

In an embodiment, the configuration information further includes an LP-WUS counter configuration.

In an embodiment, the WTRU initializes an LP-WUS counter to count a number of LP-WUS monitoring occasions (MOs) occurring after a start or resumption of monitoring the LP-WUS. The WTRU compares the number of LP-WUS MOs indicated by the LP-WUS counter with a threshold counter value indicated by the LP-WUS counter configuration. The WTRU determines that the LP-WUS is received within the monitoring duration if the number of the LP-WUS MOs is less than the threshold counter value.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example simplified receiver architecture of a WTRU utilizing a low-power wake-up signal receiver (LP-WUR) according to an embodiment;

FIGS. 3A-3B are a diagram illustrating an example physical downlink control channel (PDCCH) monitoring process with multiple main radio receiver (MR) ramp-up times according to an embodiment;

FIGS. 4A-4B are a diagram illustrating an example PDCCH monitoring process with multiple search space (SS) sets according to an embodiment; and

FIG. 5 is a flowchart illustrating an example process of monitoring multiple SS sets according to an embodiment.

### DETAILED DESCRIPTION

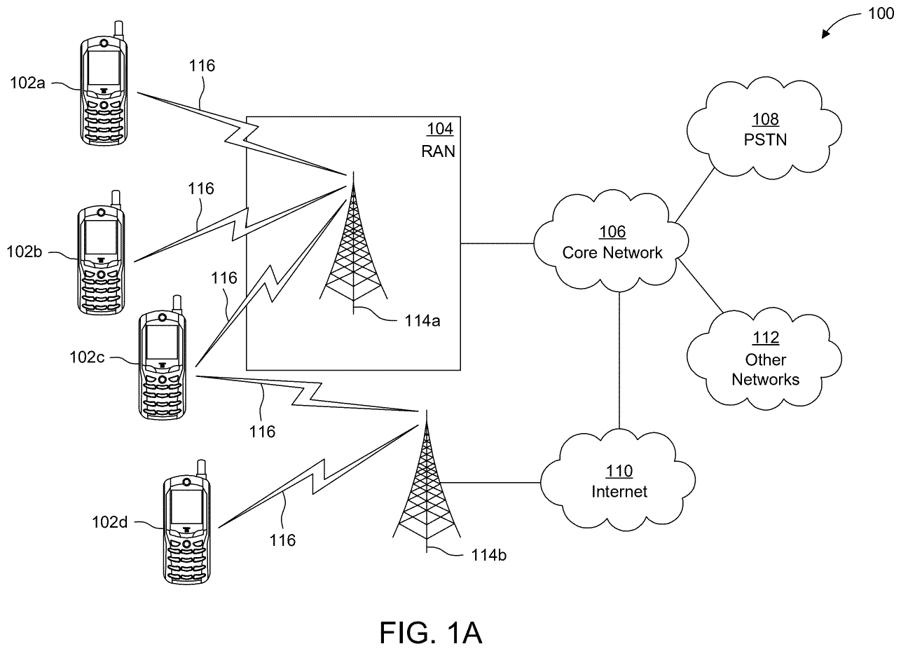

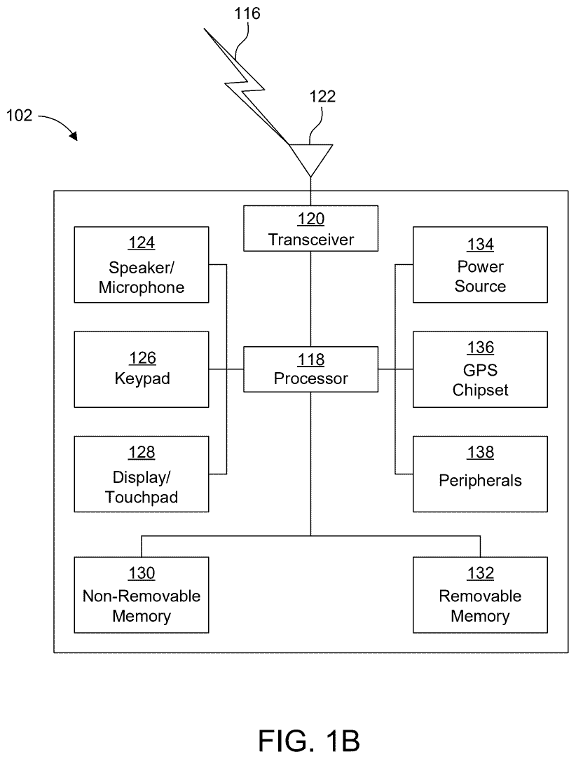

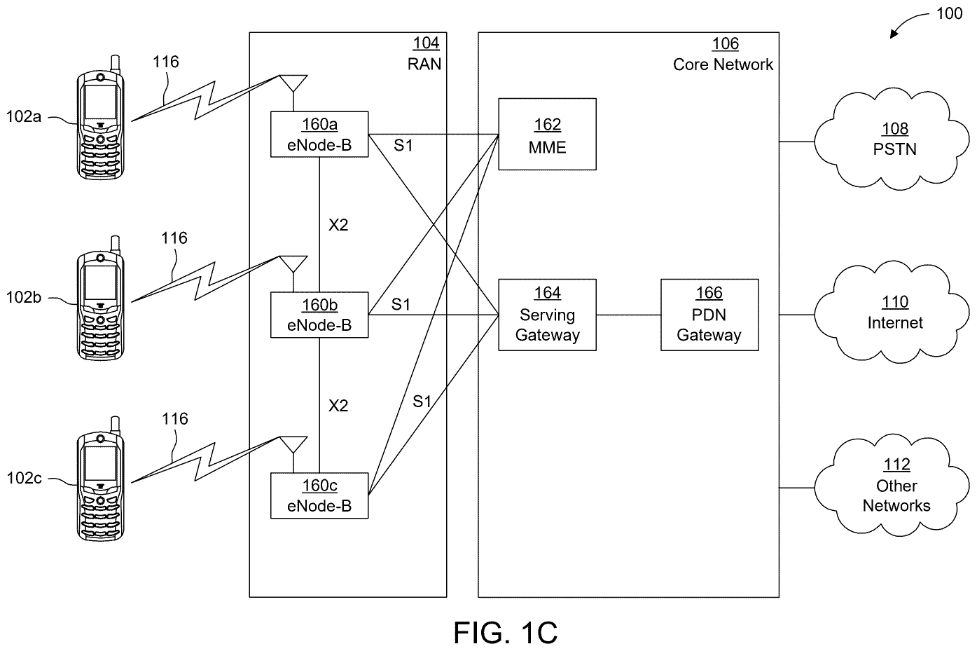

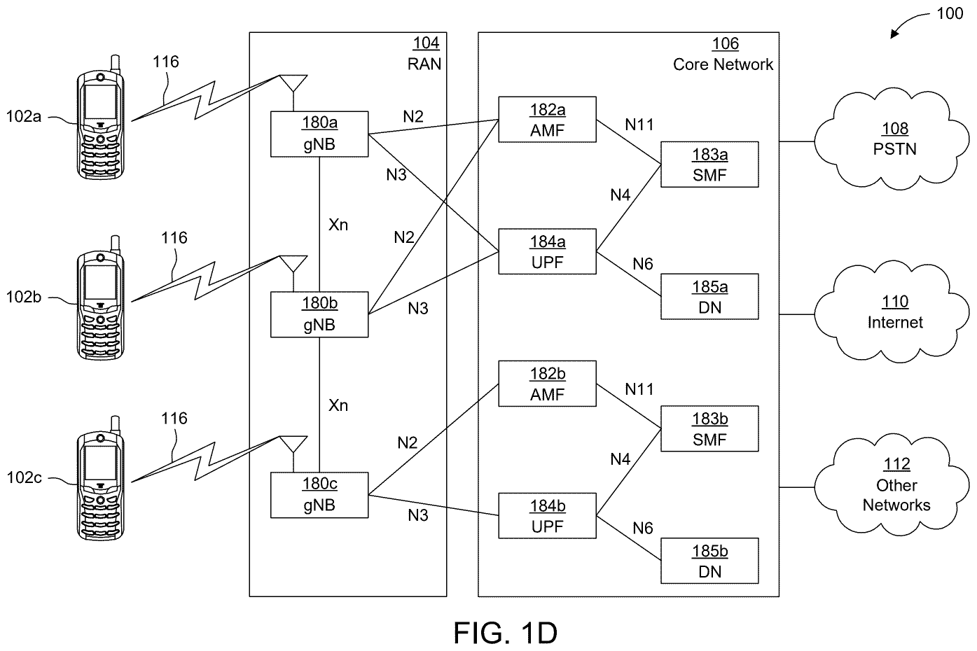

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The present disclosure relates generally to fifth generation (5G) wireless systems, and specifically to monitoring a low-power (LP) new radio (NR) wake-up signal (WUS), i.e. LP-WUS using a low-power (LP) wake-up signal radio receiver (WUR), i.e., LP-WUR. The present disclosure provides one or more power saving techniques implemented in a WTRU.

In an embodiment, the WTRU determines a main radio receiver (MR) ramp-up time as a function of a time duration for which the WTRU continuously monitors the LP-WUS. The WTRU also determines one or more physical downlink control channel (PDCCH) monitoring resources as a function of the MR ramp-up time. The WTRU determines whether to monitor the PDCCHs outside a discontinuous reception (DRX) on duration timer and/or during the DRX on duration timer based on one or more conditions experienced by the WTRU, one or more priorities of traffic, and/or one or more WTRU capabilities etc., for example.

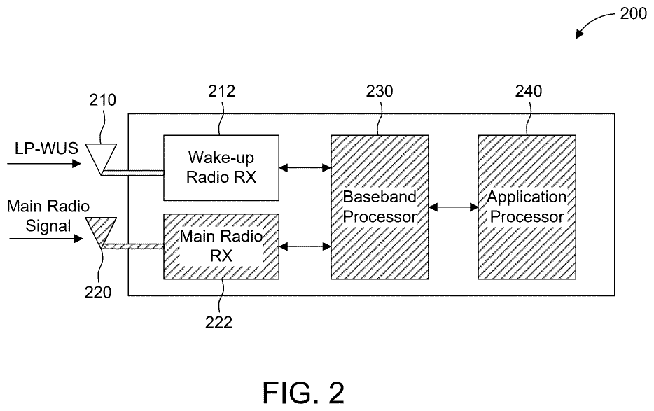

FIG. 2 is a system diagram illustrating an example simplified receiver architecture of a WTRU 200 utilizing a LP-WUR according to an embodiment. The WTRU 200 includes a first antenna 210 coupled to an LP-WUR 212, a second antenna 220 coupled to an MR 222, a baseband processor 230, and an application processor 240. The WTRU 200 may monitor and/or receive the WUS via a first radio, i.e., a low-power radio and/or an ultra-low power radio. The WUS may be the LP-WUS. The first radio may be the LP-WUR 212. The received WUS (e.g., the LP-WUS), for example via the LP-WUR 212, may trigger wake-up and/or use of a second radio of the WTRU 200, e.g., the MR 222 for data and/or control signal transmission and/or reception, as shown in FIG. 2. This reduces power consumption of wireless devices, such as the WTRU 200.

Typically, a power saving achievable through the LP-WUS monitoring depends on one or more sleep states (e.g., a deep sleep state, a light sleep state, and/or a micro sleep state etc.) that are supported by the WTRU for the MR. In an example, while monitoring the LP-WUS, the WTRU may save more power if the MR is in the deep sleep state compared to the case of the MR in the light sleep state. However, different sleep states may correspond to different MR ramp-up times and/or MR activation times (e.g., light sleep needs 3-10 ms, deep sleep needs 10-20 ms, etc.) for the MR to be ready for monitoring the PDCCH. In an example, the sleep states (e.g., the deep sleep state) that provide higher power saving may need longer MR ramp-up times and/or MR activation times compared to the sleep states (e.g., the light sleep state) that provide lower power saving. Therefore, a use of the sleep states that provide higher power saving may cause latency. Similarly, the use of the sleep states that support lower latency (due to lower corresponding MR ramp-up times and/or lower corresponding MR activation times etc., for example), may reduce power savings.

In an embodiment, the WTRU determines the MR ramp-up time (and/or the sleep state, for example) for monitoring the LP-WUS as the function of a continuous duration (e.g., without switching on the MR for monitoring the PDCCH) for which the WTRU monitors the LP-WUS. When the WUS and/or any wake-up indication is received, the WTRU determines one or more resources for monitoring the PDCCH based on the determined MR ramp-up time.

The WTRU may receive one or more configurations, one or more indications, and/or one or more configuration information from a base station (e.g. the gNB). The configuration information may include a DRX configuration, such as but not limited to, one or more DRX cycles including one or more DRX active periods and/or one or more DRX inactive (i.e. non-active) periods. The DRX configuration may include one or more timers associated with the DRX, such as but not limited to one or more DRX on duration timer, and/or one or more inactivity timers etc., for example. The WTRU may also receive one or more configurations for monitoring the LP-WUS (e.g., one or more LP-WUS occasions (LOs), and/or one or more LP-WUS monitoring occasions (MO) s, etc.).

The configuration information may also include a plurality of MR ramp-up times (e.g., a first MR ramp-up time and a second MR ramp-up time, and so on). Each MR ramp-up time may be associated with a sleep state of the MR and/or the WTRU. In an example, the first MR ramp-up time may be associated with a first sleep state and the second MR ramp-up time may be associated with a second sleep state etc. In an example, the WTRU may report two or more MR ramp-up times to the gNB (e.g., as the WTRU capability).

The configuration information may also include one or more search space (SS) sets associated with monitoring the LP-WUS (for example, the one or more SS sets for LP-WUS triggered PDCCHs etc.). The configuration information may also include one or more timers associated with monitoring the PDCCH upon receiving a trigger via the LP-WUS (e.g., an on duration timer associated with the LP-WUS etc.).

The configuration information may also include a plurality of SS sets (e.g., a first SS set and a second SS set) associated with the plurality of MR ramp-up times. In an example, the first SS set may be associated with the first MR ramp-up time and a second SS set may be associated with the second MR ramp-up time etc.

The configuration information may also include one or more configurations for determining the MR ramp-up time to be utilized for monitoring the LP-WUS and/or the PDCCHs. In an example, the configuration information may include a threshold time duration (e.g., for a timer associated with t_LPWUS_Activation), i.e. a threshold timer value, from activation and/or resumption (e.g., after a DRX active time triggered by the LP-WUS etc.) of monitoring the LP-WUS. In an example, the configuration information may include a counter (e.g., a LP-WUS MO counter) which may count one or more occurrences of one or more events (e.g., the LP-WUS MOs and/or the LOs) since activation and/or resumption of monitoring the LP-WUS. The configuration information may include a threshold counter value associated with the LPWUS MO counter.

The WTRU may receive a configuration and/or an indication for activating an LP-WUS monitoring process. The WTRU may start monitoring the LP-WUS with the first MR ramp-up time (i.e., the first sleep state of the MR). The WTRU may start tracking the t_LPWUS_Activation and/or may start the LPWUS MO counter. In an example, If the WTRU receives the LP-WUS before a preconfigured time (e.g., before the t_LPWUS_Activation exceeds the threshold timer value, and/or before the LPWUS MO counter exceeds the threshold counter value) from staring and/or resuming the LP-WUS monitoring, the WTRU determines the one or more resources for monitoring and/or for receiving the PDCCHs based on the first MR ramp-up time. The WTRU monitors for and/or receives the PDCCHs in the determined resources. In an example, the WTRU wakes-up the MR, starts one or more timers (e.g., the on duration timer for the LP-WUS) associated with the PDCCH monitoring at or at least after the first MR ramp-up time. While the one or more timers are running, the WTRU monitors for and/or receives the PDCCHs in the one or more SS sets and/or one or more configured SSs (e.g., an SS set for LP-WUS triggered PDCCHs, and/or one or more WTRU specific SS sets, and/or one or more common SS sets etc.). In an example, the

WTRU monitors for and/or receives the PDCCHs by using the first SS set (e.g., a first SS associated with the first SS set at least at or after the first MR ramp-up time).

If the WTRU does not receive the LP-WUS before the preconfigured time, the WTRU may switch to the second MR ramp-up time (i.e. switch the MR to the second sleep state). If the WTRU receives the LP-WUS after the preconfigured time, the WTRU may determine the one or more resources for monitoring and/or for receiving the PDCCHs based on the second MR ramp-up time. The WTRU may monitor for and/or receive the PDCCHs in the one or more determined resources. In an example, the WTRU wakes-up the MR, starts the one or more timers (e.g., the on duration timer for the LP-WUS and/or the DRX inactivity timer for the LP-WUS etc.) associated with the PDCCH monitoring at or at least after the second MR ramp-up time. While the one or more timers are running, the WTRU monitors for and/or receives the PDCCHs in the one or more SS sets and/or the one or more configured SSs (e.g., the one or more SS sets for the LP-WUS triggered PDCCHs, and/or the one or more WTRU specific SS sets, and/or the one or more common SS sets etc.).

The WTRU monitors for and/or receives the PDCCHs by using the second SS set (e.g., a first SS associated with the second SS set at least at or after the second MR ramp-up time). The WTRU receives one or more DL signals and/or channels (e.g., a physical downlink shared channel (PDSCH) etc.) and/or transmits one or more UL signals and/or channels (e.g., a physical uplink control channel (PUCCH) and/or a physical uplink shared channel (PUSCH) etc.) based on one or more indications received in one or more received PDCCHs.

After an active time triggered by the LP-WUS is over, the WTRU resets the timer (i.e. the t_LPWUS_Activation) and/or the LP-WUS MO counter. The WTRU resumes the LP-WUS monitoring with the first MR ramp-up time corresponding to the first sleep state of the MR.

In an example, the methods and systems disclosed in the present disclosure increase power saving achievable through the LP-WUS monitoring. The present disclosure also facilitates reduction in latency caused by the MR ramp-up times for the LP-WUS monitoring by the WTRU.

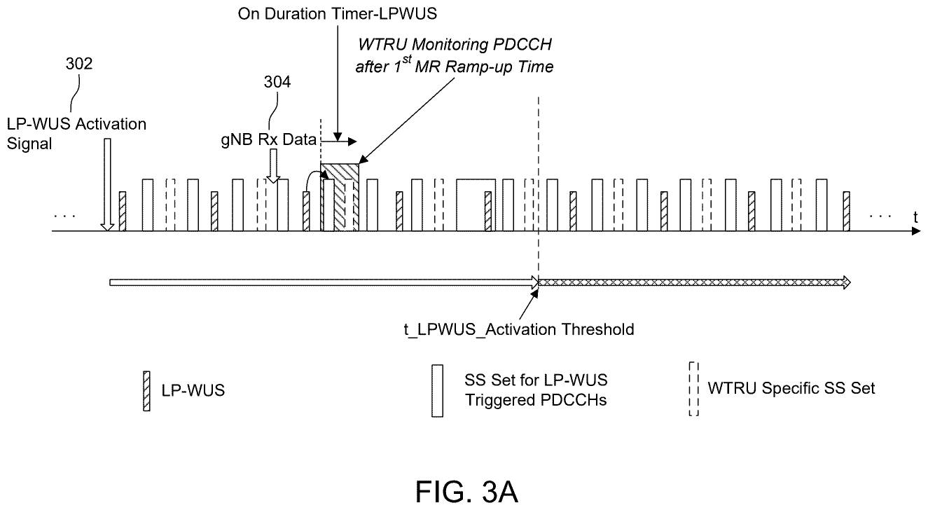

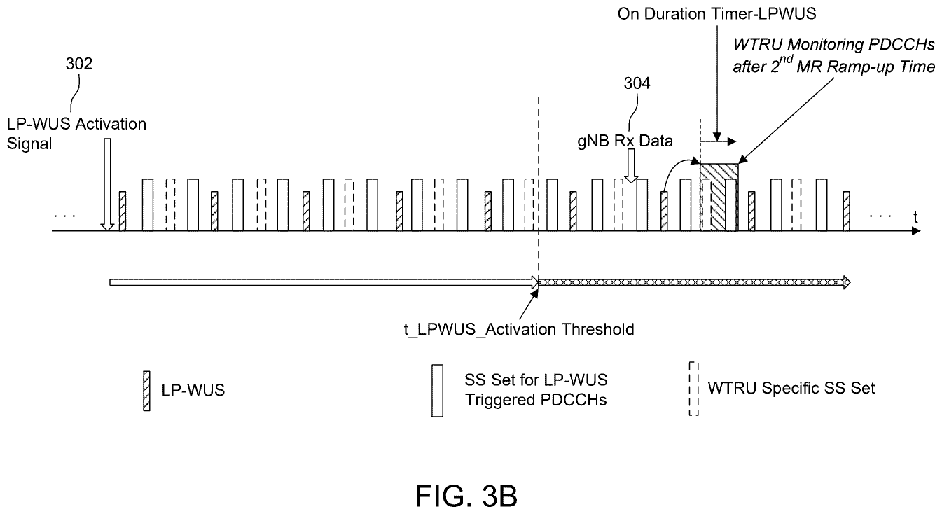

FIGS. 3A-3B are a diagram illustrating an example PDCCH monitoring process with multiple MR ramp-up times according to an embodiment. The WTRU may receive an LP- WUS activation signal 302 indicative of start of a low-power state and/or start of the LP-WUS monitoring process. The WTRU may also receive gNB data 304 from the gNB. The WTRU may determine the MR ramp-up time (e.g. the sleep state of the MR) for the LP-WUS monitoring as the function of the continuous duration (e.g., without switching on the MR for the PDCCH monitoring) for which the WTRU monitors the LP-WUS. When the wake-up indication, the WUS and/or the LP-WUS is received, the WTRU may determine the one or more resources for the PDCCCH monitoring based on the determined MR ramp-up time. The WTRU may monitor for and/or receive the PDCCHs in the determined one or more resources. In an example, the WTRU may receive the one or more configurations and/or the one or more indications via a radio resource control (RRC) signaling, a downlink control information (DCI) indication, a medium access control-control element (MAC-CE) indication, and/or system information (SI) etc., for example.

The WTRU may receive the one or more configurations (e.g., DRX configuration information) associated with a DRX mode of the base station and/or the cell. The DRX configuration information may include one or more of: a starting location of one or more DRX cycles, one or more DRX cycle durations, one or more timers associated with the one or more DRX cycles (for example, one or more on duration timers (i.e. the DRX-onDuration Timers) and/or one or more inactivity timers etc.) associated with monitoring the one or more downlink (DL) signals and/or channels (e.g., the PDCCHs, and/or the DCIs etc.). The WTRU may receive the configuration information for the one or more timers associated with one or more uplink (UL) re-transmissions (e.g. a DRX-Retransmission-TimerUL). The WTRU may receive the configuration information for the one or more timers associated with DL re-transmissions (e.g. a DRX-Retransmission-TimerDL). The WTRU may receive the configuration information for the one or more timers associated with a hybrid automatic repeat request (HARQ) (e.g., a DRX-HARQ-RTT-TimerUL and/or a DRX-HARQ-RTT-TimerDL etc.).

The WTRU may receive the configuration information for the LP-WUS monitoring process. In that, the WTRU may receive the configuration of the one or more LOs and/or the one or more LP-WUS MOs associated with each LO. For example, the WTRU may receive the configuration information (e.g., based on one or more offsets with respect to starting resource of the DRX-onDurationTimer, periodicity etc., received via the RRC signaling, the SI, and/or the MAC-CE indication etc.) of the one or more LOs per DRX (e.g., a C-DRX) cycle. The WTRU may receive the configuration information (e.g., based on one or more offsets with respect to starting resources of the one or more LOs etc.) of one or more (K) LP-WUS MOs (e.g., the one or more resources for receiving the LP-WUS) within each LO. In the case the LP-WUS is supported with multiple (N) beams, the WTRU may receive the configuration of NxK LP-WUS MOs for each LO.

In an example, the WTRU may receive the indication and/or may utilize modulations such as but not limited to OOK1, OOK4, etc., for example.

The configuration information may include the plurality of MR ramp-up times, for example, the first MR ramp-up time and/or the second MR ramp-up time etc. Each MR ramp-up time may be associated with a respective sleep state. In an example, the first MR ramp-up time may be associated with the first sleep state (e.g., the light sleep state) and the second MR ramp-up time may be associated with the second sleep state (e.g., the deep sleep state).

The plurality of MR ramp-up times may refer to a time (e.g., a minimum time) required by the WTRU for the MR to be ready for receiving and/or transmitting signals and/or channels after the indication is received (e.g., after the indication to wake-up is received via the LP-WUS etc.).

The plurality of MR ramp-up times may refer to a PDCCH monitoring preparation time. In an example, the MR ramp-up time may refer to the time (e.g., the minimum time) required for the WTRU to prepare for the PDCCH monitoring once the indication to wake-up is received via the LP-WUS etc.

The plurality of MR ramp-up times may refer to a warm-up time. In an example, plurality of MR ramp-up times may refer to the time (e.g., the minimum time) required for the WTRU to warm-up and/or for the MR to be ready for receiving the one or more signals and/or channels (e.g., the PDCCHs etc.).

The plurality of MR ramp-up times may refer to the time (e.g., the minimum time) required by the WTRU for the MR to be ready for receiving and/or transmitting signals and/or channels after the WTRU determines to wake-up the MR (e.g., the WTRU determines to wake-up the MR upon failure to detect one the or more LP-WUSs etc.).

In an example, the WTRU may report the plurality of MR ramp-up times to the base station (i.e. the gNB). In an example, the WTRU may report the plurality of MR ramp-up times to the gNB in a WTRU capability indication (e.g., via the MAC-CE indication and/or the PUCCH indication etc.). In an example, the WTRU may report the plurality of MR ramp-up times that the WTRU supports in response to a WTRU capability inquiry received from the gNB (e.g., via the SI, the RRC signaling, the MAC-CE indication, and/or the DCI indication etc.)

The configuration information may include a plurality of MR ramp-up time patterns. The plurality of MR ramp-up time patterns may include a duration (e.g., a fraction of DRX cycles, ms, a number of slots, and/or number of frames etc.) for each MR ramp-up time and/or each MR ramp-up pattern. In an example, the first MR ramp-up time pattern may include the first MR ramp-up time for first N1 slots, the second MR ramp-up time for next N2 slots, a third MR ramp-up time for next N3 slots, and so on, for example. The second MR ramp-up time pattern may include the first MR ramp up time for first N1 slots, the second MR ramp-up time for next N2+N3 slots, and so on, for example. The third MR ramp-up time pattern may include the first MR ramp-up time for N1+N2+N3 slots, for example. Each MR ramp-up time pattern may be associated with one or more MR sleep state patterns. In an example, the first MR ramp-up time is associated with the first sleep state, the second MR ramp-up time is associated with the second sleep state, and the third MR ramp-up time is associated with the third sleep state. In this case, the first MR sleep state pattern may include the first sleep state for the first N1 slots, the second sleep state for the next N2 slots, the third sleep sate for next N3 slots, for example. The second MR sleep state pattern may include the first sleep state for the first N1 slots, the second sleep state for the next (N2+N3) slots, and so on, for example. The third MR sleep state pattern may include the first sleep state for the N1+N2+N3 slots etc., for example.

The configuration information may include the SS set associated with the LP-WUS monitoring. In an example, the WTRU may receive the one or more configurations of the one or more SS sets for monitoring and/or receiving the LP-WUS triggered PDCCHs.

The configuration information may include a plurality of SS sets. Each SS set may be associated with at least one MR ramp-up time. In an example, the first SS set may be associated with the first MR ramp-up time, the second SS set may be associated with the second MR ramp-up time etc., for example.

The configuration information may include one or more timers associated with monitoring for the DL signals and/or channels (e.g., the PDCCHs). In an example, the WTRU may receive the configuration of the one or more timers associated with monitoring and/or receiving the PDCCHs after receiving the wake-up indication via the LP-WUS. The one or more timers may include an on duration timer (e.g. the on duration timer LP-WUS), and/or an inactivity timer (e.g. the inactivity timer LP-WUS). The on duration timer may refer to a timer which starts after receiving the wake-up indication via the LP-WUS (and/or after a time offset from the reception of the LP-WUS, after a time offset from the staring position of a MO and/or a LO, after the LP-WUS carrying the wake-up indication is received and/or at a preconfigured time etc.). While the on duration timer LP-WUS is running, the WTRU may monitor for and/or receive the PDCCHs (e.g., monitor for and/or receive the PDCCHs in the SS set associated with the LP-WUS). The inactivity timer LP-WUS may refer to a timer which starts in the case the WTRU receives at least one signal and/or channel (e.g., the PDCCH and/or the LP-WUS etc.) while the on duration timer is running. The inactivity timer may start immediately after receiving the at least one signal and/or the channel while the on duration timer LP-WUS is running and/or may start at an end of the on duration timer LP-WUS.

The configuration information may include a plurality of sets of timers (e.g. a first set of timers, a second set of timers, and so on) for receiving the DL signals and/or channels and/or for transmitting the UL signals and/or channels (e.g., the PDCCHs, the PDSCHs, the PUCCHs, the PUSCHSs, an HARQ acknowledgement (ACK), and/or a scheduling request (SR), etc.) in the DRX active time triggered via the LP-WUS. Each set of timers may include the one or more timers (e.g., the on duration timer, the inactivity timer, the short DRX cycle timer, the one or more timers associated with the HARQ, and/or the one or more timers associated with re-transmissions etc.).

The configuration information may include the configuration of the plurality of sets of timers and an association between the plurality of sets of timers and the plurality of MR ramp-up times and/or the plurality of MR ramp-up time patterns. The WTRU may receive the association between the plurality of MR ramp-up times and the one or more set of timers. In an example, the WTRU may receive the configuration that the first set of timers is associated with the first MR ramp-up time, and the second set of timers is associated with the second MR ramp-up time etc., and so on. The WTRU may receive the association between the plurality of MR ramp-up time patterns and the plurality of sets of timers. In an example, the WTRU may receive the configuration that the first MR ramp-up time pattern is associated with the first set of timers, and the second MR ramp-up time pattern is associated with the second set of timers etc., and so on.

The configuration information may include one or more PDCCH monitoring windows and an association between the one or more PDCCH monitoring windows and one or more MR ramp-up times. In an example, a first monitoring window may be associated with the first MR ramp-up time, a second monitoring window may be associated with the second MR ramp-up time etc., and so on. The configuration for the one or more monitoring windows may include a duration of each monitoring window (e.g., a first duration associated with the first monitoring window, a second duration associated with the second monitoring window etc.) and/or a starting position of each monitoring window. In an example, the WTRU may receive the configuration that the first monitoring window starts at a first offset (e.g., a number of slots, symbols, ms etc.) from the LP-WUS MO (e.g., one or more starting location slots, and/or time, and/or symbols etc.) of the LP-WUS MO in which the LP-WUS indication to wake up is received where the first offset may be greater than or equal to the first MR ramp-up time (i.e. the first offset≥the first MR ramp-up time). The second monitoring window may start at a second offset from the LP-WUS MO where the second offset may be greater than or equal to the second MR ramp-up time (i.e. the second offset >the second MR ramp-up time).

The configuration information may include the one or more configurations for determining the MR ramp-up time. In an example, the configuration information may include the threshold on time duration (i.e. the t_LPWUS_Activation etc.) e.g. the threshold timer value from the activation and/or resumption (e.g., the WTRU resumes to monitor the LP-WUS after completing an MR active time (e.g., the MR active time for the PDCCH monitoring etc.) triggered by the LP-WUS) of the LP-WUS monitoring. In an example, the t_LPWUS_Activation may track a time elapsed since activation and/or resumption of the LP-WUS monitoring in terms of ms, and/or slots, and/or symbols, and/or number of DRX cycles, etc.

The configuration information may include the timer (e.g. the LP-WUS monitoring timer etc.) which tracks the time from the activation and/or resumption of the LP-WUS monitoring. The configuration information may include the counter (e.g. the LP-WUS MO counter) which counts the number occurrences of the one or more events (e.g., the LP-WUS MOs, the LOs, the LP-SS reception and/or MOs etc.) since activation and/or resumption of the LP-WUS monitoring. The configuration of the counter may include the threshold associated with the counter, e.g. the threshold counter value.

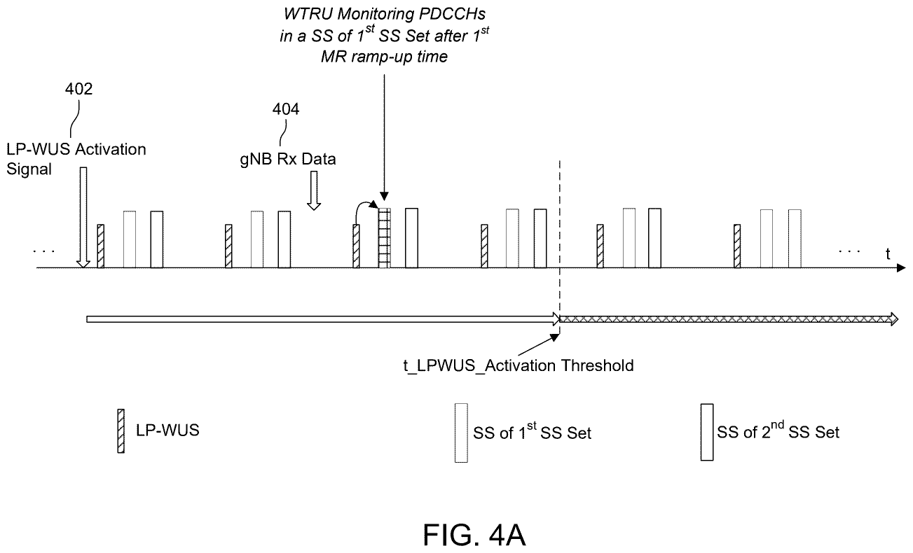

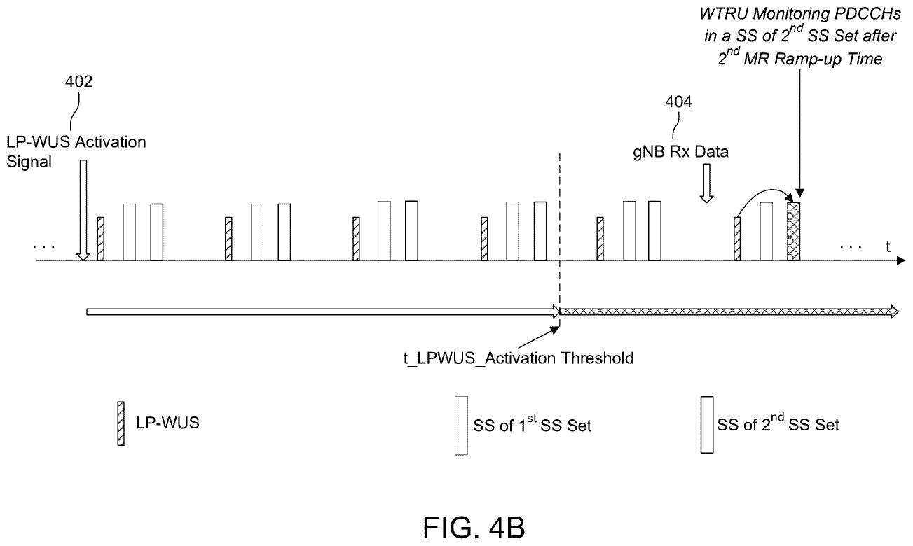

FIGS. 4A-4B are a diagram illustrating an example PDCCH monitoring process with multiple SS sets according to an embodiment. The WTRU may receive an LP-WUS activation signal 402 indicative of start of the low-power state and/or start of the LP-WUS monitoring process. The WTRU may also receive gNB data 404 from the gNB. The WTRU may determine the MR ramp-up time and/or the PDCCH monitoring resources based on the duration for which the WTRU monitors the LP-WUS continuously. To determine the MR ramp-up time (and/or the sleep state) and/or the one or more resources to monitor and/or receive the one or more DL signals and/or channels (e.g., the PDCCHs), the WTRU may receive one or more corresponding configurations from the base station.

The WTRU may receive the one or more configurations and/or the one or more indications to activate the LP-WUS monitoring. In an example, the WTRU may receive (e.g., via the RRC signaling) the one or more configurations (e.g., the one or more configurations of the LP-WUS MO, the LO, a signal structure, the one or more MR ramp-up times, and/or the one or more MR ramp-up time patterns, etc.) associated with the LP-WUS monitoring. In an example, the WTRU may receive (e.g., via the MAC-CE indication and/or the DCI indication) the indication to start monitoring the LP-WUS.

The WTRU may start monitoring the LP-WUS with the first MR ramp-up time. The first MR ramp-up time may correspond to the first sleep state of the MR and/or the WTRU. In an example, the WTRU may start monitoring the LP-WUS at a first LO and/or a first LP-WUS MO (e.g., starting from a first symbol of the LO and/or the LP-WUS MO etc.) located at least a preconfigured offset (e.g., via the RRC signaling, the MAC-CE indication, and/or the DCI indication) from the time the WTRU receives the indication and/or the configuration for monitoring the LP-WUS.

The WTRU may start monitoring the LP-WUS after the preconfigured offset (e.g., configured via the RRC signaling, the MAC-CE indication, and/or the DCI indication etc.) from the reception of the indication and/or the configuration (e.g., via the RRC signaling, the MAC-CE indication, and/or the DCI indication etc.) for the LP-WUS monitoring. In an example, the WTRU may start monitoring the LP-WUS after the preconfigured offset from the first symbol of the PDCCH which indicates the WTRU to monitor the LP-WUS.

The WTRU may start the LP-WUS monitoring from the first starting position out of a set of preconfigured starting positions (e.g. via the RRC signaling, the MAC-CE indication, and/or the DCI indication etc. and/or periodic positions etc.) for the LP-WUS monitoring timer.

The WTRU may start the LP-WUS monitoring at the start of first slot and/or the first frame that begins after the preconfigured offset (e.g., the RRC signaling, the MAC-CE indication, and/or the DCI indication etc.) from the reception of the configuration (e.g., the RRC configuration) for the LP-WUS monitoring.

The WTRU may start tracking time duration (i.e. the t_LPWUS_Activation) elapsed since starting to monitor the LP-WUS and/or the WTRU may start the LP-WUS MO counter and/or the LP-WUS monitoring timer at the start of the LP-WUS monitoring.

If the WTRU receives the LP-WUS (e.g., the indication to wake-up for monitoring the PDCCHs) before the preconfigured time from starting to monitor and/or from resuming to monitor the LP-WUSs, the WTRU may monitor and/or receive the PDCCHs based on the first MR ramp-up time. In an example, if the WTRU receives the LP-WUS before the t_LPWUS_Activation exceeds the threshold timer value and/or before the LP-WUS MO counter exceeds the threshold counter value and/or before the LP-WUS monitoring timer expires, the WTRU may wake up the MR and monitor for and/or receive the PDCCHs at or at least after the first MR ramp-up time. In an example, the time duration from the WTRU starting or resuming to monitor for the LP-WUS to a threshold associated with the t_LPWUS_Activation may be referred to as a monitoring duration, consistent with the present disclosure. In an example, the time duration from the WTRU starting or resuming to monitor for the LP-WUS to the time the LP-WUS MO counter exceeds the threshold counter value may be referred to as the monitoring duration, consistent with the present disclosure. In an example, the time duration from the WTRU starting or resuming to monitor for the LP-WUS to the time the LP-WUS monitoring timer expires may be referred to as the monitoring duration, consistent with the present disclosure. In an example, the monitoring duration may be referred to as a first monitoring duration and a time duration after the monitoring duration may be referred to as a second monitoring duration, consistent with the present disclosure.

The WTRU may start the first set of timers (e.g., the on duration timer LP-WUS, and/or the inactivity timer LP-WUS associated with the first set of timers) associated with the PDCCH monitoring at least at or after the first MR ramp-up time.

While the one or more timers (e.g., the on duration timer LP-WUS and/or the inactivity timer LP-WUS associated with the first set of timers) are running, the WTRU may monitor for and/or receive the PDCCHs in the one or more SS sets and/or the one or more configured SSs. In an example, the WTRU may monitor for and/or receive the PDCCHs in the SS set for the LP-WUS triggered PDCCHs, and/or the one or more WTRU specific SS sets, and/or the one or more common SS sets.

While the one or more timers (e.g., the on duration timer LP-WUS, and/or the inactivity timer LP-WUS associated with the first set of timers) are running, the WTRU may monitor for and/or receive the PDCCHs by using the first SS set. In an example, the WTRU may monitor for and/or receive the PDCCHs in the SS associated with the first SS set and located at least at or after the first MR ramp-up time.

The WTRU may monitor for and/or receive the PDCCHs in the one or more SSs associated with the configured (e.g., via the RRC signaling and/or the SI etc.) one or more SS sets and/or located within the first PDCCH monitoring window.

The WTRU may monitor for and/or receive the PDCCHs in the SS associated with the configured SS set (e.g., via the RRC signaling and/or the SI etc.) and/or located at the preconfigured first offset (e.g., configured via the RRC signaling, the MAC-CE indication, and/or the DCI indication etc.). The preconfigured offset may be greater than or equal to the first MR ramp-up time (i.e. the preconfigured offset≥first MR ramp-up time).

If the WTRU does not receive the LP-WUS indicating to wake-up (e.g., for monitoring the PDCCHs) before the preconfigured time from starting to monitor the LP-WUS and/or resuming monitoring the LP-WUS, the WTRU may switch to the second MR ramp-up time (and/or switch to the second sleep state). In an example, if the WTRU does not receive the LP-WUS before the t_LPWUS_Activation timer exceeds the threshold timer value and/or the WTRU does not receive the LP-WUS before the LP-WUS MO counter exceeds the threshold counter value, and/or the WTRU does not receive the LP-WUS before the LP-WUS monitoring timer expires, the WTRU may switch to the second MR ramp-up time (and/or the WTRU switches to the second sleep state).

The WTRU may indicate switching the MR ramp-up time (and/or switching to the second sleep state) to the gNB by using one or more preconfigured resources (e.g., configured via the RRC signaling, the MAC-CE indication, and/or the DCI indication and/or the resources such as but not limited to the PUCCH resources, the SRS, and/or the PRACH etc.). In an example, when the WTRU determines to switch the MR ramp-up time to the second MR ramp-up time, the WTRU may turn on the MR and/or report the MR ramp-up time switching to the gNB by transmitting the PUCCH (e.g., a 1 bit indication in the PUCCH etc.). In an example, the WTRU may report switching the MR ramp-up time by transmitting a preconfigured SRS resource and/or a preamble in one or more PRACH resources.

If the WTRU receives the LP-WUS after the preconfigured time from starting monitoring and/or resuming monitoring the LP-WUS, the WTRU may monitor for and/or receive the PDCCHs based on the second MR ramp-up time. In an example, if the WTRU receives the LP-WUS after the t_LPWUS_Activation exceeds the threshold timer value and/or the LPWUS MO counter exceeds the threshold counter value and/or the LPWUS monitoring timer expires, the WTRU may monitor for and/or receive the PDCCHs at or at least after the second MR ramp-up time.

The WTRU may start the second set of timers (e.g., the on duration timer LP-WUS, the inactivity timer LP-WUS associated with the second set of timers etc.) associated with the PDCCH monitoring at or at least after the second MR ramp-up time.

While the one or more timers (e.g., the on duration timer LP-WUS and/or the inactivity timer LP-WUS associated with the second set of timers etc.) are running, the WTRU may monitor for and/or receive the PDCCHs in the one or more SS sets and/or the one or more configured SSs. In an example, the WTRU may monitor for and/or receive the PDCCHs in the SS set for the LP-WUS triggered PDCCHs, and/or all the WTRU specific SS sets, and/or the one or more common SS sets.

While the one or more timers (e.g., the on duration timer LP-WUS and/or the inactivity timer LP-WUS associated with the second set of timers etc.) are running, the WTRU may monitor for and/or receive the PDCCHs by using the second SS set. For example, the WTRU may monitor for and/or receive the PDCCHs in the SS associated with the second SS set and/or located at least at or after the second MR ramp-up time.

The WTRU may monitor for and/or receive the PDCCHs in the one or more SSs associated with one or more preconfigured SS sets (e.g., via the RRC signaling and/or the SI etc.) and located within the second PDCCH monitoring window.

The WTRU may monitor for and/or receive the PDCCHs in the SS associated with the preconfigured SS set (e.g., via the RRC signaling and/or SI etc.) and located at the configured (e.g., configured via the RRC signaling, the MAC-CE indication, and/or the DCI indication etc.) second offset where the second offset is greater than or equal to the second ramp-up time (i.e. the second offset≥the second MR ramp-up time).

The WTRU receives the one or more DL signals and/or channels (e.g., the PDSCH) and/or transmits the one or more UL signals and/or channels (e.g., the PUCCH and/or the PUSCH etc.) based on the indication in the received PDCCHs. In an example, if the WTRU monitors for and/or receives the PDCCHs based on the MR ramp-up time, the WTRU may use the one or more timers (e.g., the timers associated with the HARQ etc.) associated with the first set of timers and/or report the HARQ ACK and/or the NACK for the one or more received DL signals and/or channels (e.g., the PDSCH etc.).

If the WTRU monitors for and/or receives the PDCCHs based on the second MR ramp-up time, the WTRU may use the one or more timers (e.g., the one or more timers associated with the HARQ) associated with the second set of timers and report the HARQ ACK and/or NACK for the one or more received DL signals and/or channels (e.g., the PDSCH).

If the WTRU monitors for and/or receives the PDCCHs based on the first MR ramp-up time, the WTRU may use the one or more timers (e.g., the one or more timers associated with retransmission etc.) associated with the first set of timers and/or receive the DL retransmissions and/or perform the UL retransmissions.

If the WTRU monitors for and/or receives the PDCCHs based on the second MR ramp-up time, the WTRU may use the one or more timers (e.g., the one or more timers associated with the retransmission etc.) associated with the second set of timers and receive the DL retransmissions and/or perform the UL retransmissions.

The WTRU may determine the end of an MR active time triggered by the LP-WUS based on end of the configured one or more timers. In an example, in case no retransmission and/or HARQ related timers are configured, the WTRU may determine that the MR active time ends when the DRX inactivity timer (e.g., the DRX inactivity timer LP-WUS) expires. In another example, in case the retransmission, the HARQ related and/or the DRX inactivity timers are not configured, the WTRU may determine that the MR active time ends when the DRX on duration timer LP-WUS (e.g., the DRX on duration timer LP-WUS) expires.

After the MR active time triggered by the LP-WUS, the WTRU may resume the LP-WUS monitoring and/or follow the legacy MR procedure (e.g., monitor for and/or receive the DL signals and/or channels and transmit the UL signals and/or channels based on the DRX configuration). In an example, after the active time triggered by the LP-WUS, the WTRU may resume the LP-WUS monitoring with the first MR ramp-up time (corresponding to the first sleep state). In an example, the WTRU may resume the LP-WUS monitoring at the next configured LO and/or MO. The WTRU may resume the LP-WUS monitoring after the preconfigured time offset (e.g., configured via the RRC signaling, the MAC-CE indication, and/or the DCI indication etc.) from the expiry of the last timer (e.g., DRX on duration timer LP-WUS and/or DRX inactivity timer LP-WUS associated with the triggered active time) associated with the MR active time.

The WTRU may resume the LP-WUS monitoring from the first starting position out of a set of configured (e.g., periodic) starting positions for the LP-WUS monitoring timer. The WTRU may reset the t_LPWUS_Activation and/or reset the LP-WUS MO counter and/or reset the LP-WUS monitoring timer with the resumption of the LP-WUS monitoring. In an example, the WTRU may reset the t_LPWUS_Activation and start tracking the time duration since resumption of the LP-WUS at the first symbol of the next occasion of the LO and/or the LP-WUS MO. The WTRU may reset the LPWUS MO counter and/or resume the LP-WUS monitoring at the next occasion of the LO and/or the LP-WUS MO. The WTRU may reset the LP-WUS monitoring timer and/or resume the LP-WUS monitoring from the first symbol of the next occasion of the LO and/or the LP-WUS MO. The WTRU may reset the LP-WUS monitoring timer and/or resume the LP-WUS monitoring after the preconfigured time offset (e.g., via the RRC signaling, the MAC-CE indication, the DCI indication, and/or the SI etc.) from the expiry of the last timer associated with the MR active time. The WTRU may reset the LP-WUS monitoring timer and/or resume the LP-WUS monitoring from the first starting position out of the set of configured (e.g., periodic) starting positions for the LP-WUS monitoring timer.

In an example, the WTRU determines the MR ramp-up time and/or the one or more resources for monitoring the PDCCHs based on the one or more MR ramp-up time patterns. The WTRU may determine the location for monitoring the PDCCH (e.g., the PDCCH search space) after receiving the wake-up indication based on the ramp-up time for the MR. The WTRU may determine the ramp-up time for the MR based on the set of ramp-up time patterns, for example. In an example, the WTRU may receive the wake-up indication while the WTRU is in one of the plurality of ramp-up times in the MR ramp-up time pattern. The WTRU may implicitly and/or explicitly determine the MR ramp-up time pattern based on one or more parameters, one or more threshold values, one or more triggering conditions, the one or more configurations and/or the one or more indications and/or the configuration information received by the WTRU from the network and/or the gNB (e.g., via the RRC signaling, the MAC-CE indication, the DCI indication, and/or the SI etc.).

The WTRU may receive the explicit configuration and/or the indication from gNB. In an example, the WTRU may receive the configuration and/or the indication from the network providing explicit information including the one or more MR ramp-up time patterns that the WTRU may use. The WTRU may receive the configuration and/or the indication information via an access stratum (AS) layer signaling (e.g. the RRC signaling and/or the messages, the MAC CE, and/or the DCI etc.), for example. The WTRU may receive the configuration associated with the periodicity of the LP-WUS.

The WTRU may be configured to select the MR ramp-up time pattern from the set of MR ramp-up time patterns based on the LP-WUS monitoring periodicity. In an example, a longer LP-WUS monitoring interval (and/or period) may implicitly indicate that the WTRU may select the MR ramp-up time pattern with longer ramp-up times. In an example, a shorter LP-WUS monitoring interval (and/or period) may implicitly indicate the WTRU may select the ramp-up time pattern with the short ramp-up time.

The WTRU may receive the configuration of the type of waveform used for the LP-WUS. In an example, the WTRU may be configured to select the MR ramp-up time pattern from the set of ramp-up time patterns based on the type of LP-WUS waveform the WTRU is configured to receive. The WTRU may implicitly determine the MR ramp-up time pattern that the WTRU may select based on the relative processing time and/or complexity required at the receiver for processing the type of LP-WUS waveform. In an example, if the LP-WUR in the WTRU is configured to receive a simple OOK type waveform which may require a short processing time, the WTRU may select the MR ramp-up time pattern with a shorter ramp-up time. If, however, the LP-WUR in the WTRU is configured to receive an OFDM based waveform requiring a relatively longer processing time, the WTRU may select the MR ramp-up time pattern with the longer ramp-up time.

The WTRU may receive the configuration associated with the DRX cycle and the corresponding threshold. In an example, the WTRU may be configured to select the MR ramp-up time pattern from the set of ramp-up time patterns based on the length of the DRX cycle configured relative to one or more thresholds. In an example, for a given configured threshold, if the length of the DRX cycle is greater than the threshold, the WTRU may use MR ramp-up time pattern, P1, whereas if the length of the DRX cycle is less than the threshold, the WTRU may use the MR ramp-up time pattern, P2.

The WTRU may receive the configuration of whether or not the LP-WUS monitoring outside legacy DRX active time is configured and/or enabled. In an example, the WTRU may be configured to use the MR ramp-up time pattern, P1, if the WTRU is configured and/or enabled to monitor the LP-WUS outside of the legacy DRX active time and/or use the MR ramp-up time pattern, P2, if the WTRU is not configured and/or enabled to monitor the LP-WUS outside of the legacy DRX active time.

The WTRU may receive the configuration information indicative of whether the WTRU is configured with the short-drx. In an example, if the short-drx is configured (e.g., the WTRU is configured with both short-drx and long-drx), the WTRU may select the MR ramp-up time pattern corresponding to the higher MR ramp-up times. If the WTRU is not configured with the short-drx (e.g., the WTRU is only configured with long-drx), the WTRU may select the MR ramp-up time pattern corresponding to the shorter MR ramp-up times.

After receiving, from the network, the configuration and/or indication information for determining and/or selecting the MR ramp-up time pattern, the WTRU may receive configuration and/or indication for activating monitoring of the LP-WUS. The WTRU may also receive the indication and/or configuration including information regarding the initial MR ramp-up time in the set of MR ramp-up time patterns that the WTRU may employ during the PDCCH monitoring.

In one solution, the WTRU may start monitoring the LP-WUS for the wake-up indication and start the timer and/or the counter for switching to the next MR ramp-up time in the set of configured ramp-up time patterns. In an example, the WTRU may be configured with the time threshold related to the timer and/or counter for switching to the next MR ramp-up time in the set of ramp-up time pattern.

The WTRU may perform one or more actions while monitoring the LP-WUS, depending on when the WTRU receives the wake-up indication from the network during one of the MR ramp-up times in the MR ramp-up time pattern in use.

If, during monitoring of the LP-WUS and while in one of the MR ramp-up timers in use, the WTRU receives the indication to wake-up, then the WTRU may wake the MR and initiate monitoring of the PDCCH within a determined set of resources associated with the MR ramp-up time in use. In an example, the WTRU may be configured to determine the resource set for monitoring of the PDCCH based on the MR ramp-up time which is in use. The WTRU may use a configured set of timers for determining the resource set for the PDCCH monitoring. In an example, the WTRU may start the on duration timer LP-WUS, during which the WTRU may monitor for the PDCCH at or after the MR ramp-up time in use has elapsed and the MR is awake.

In an example, the WTRU may start monitoring for the PDCCH while the LP-WUS triggered on duration timer is running. The WTRU may determine the set of configured resources (e.g., the WTRU specific and/or common SS sets) for the LP-WUS triggered PDCCH monitoring based on the MR ramp-up time that was in use when the wake-up indication was received. In an example, the WTRU may receive the PDCCH before the expiry of the LP-WUS triggered on duration timer, within the determined set of resources (e.g., the SS set) associated with the MR ramp-up time in use when the wake-up indication is received. In an example, the WTRU may cycle through all the MR ramp-up times in the set of ramp-up time patterns repeatedly one or more times before receiving the wake-up indication.

In one solution, the WTRU may receive one or more PDCCH (e.g., with the DCI including the indication of resource grant and/or allocation for the PDSCH reception and/or the PUSCH, the HARQ-ACK indication and/or the set of resources for the retransmission etc.). The WTRU may also receive (e.g., the PDSCH) and/or transmit (e.g., the PUSCH) data in the set resources assigned to the physical channel. In an example, the WTRU may continue monitoring of the LP-WUS with the associated MR ramp-up time pattern after expiry of the LP-WUS triggered on duration timer, and/or the inactivity timer.

The WTRU may determine the LP-WUS MOs and/or the LO based on the time duration since starting and/or resuming monitoring for the LP-WUS. In an example, the WTRU may determine the LP-WUS MOs and/or the LO for monitoring and/or receiving the LP-WUS based on the time duration since starting and/or resuming to monitor the LP-WUS. In an example, the WTRU may receive the one or more configurations. The WTRU may receive the one or more configurations and/or indications via the RRC signaling, the MAC-CE indication, the DCI indication, and/or the SI etc., for example.

The WTRU may receive the configuration for the PDCCH MOs. In an example, the WTRU may receive a set of (e.g., periodic) PDCCH monitoring occasions associated with the LP-WUS monitoring. In an example, the WTRU may receive the configuration of (e.g., periodic) starting locations for the DRX on duration timer (e.g., the DRX on duration timer LP-WUS etc.). In an example, the WTRU may receive the configuration for determining one or more paging occasions for monitoring a page (e.g., monitoring for the PDCCH carrying a page) and/or a paging signal.

The WTRU may receive the plurality of offsets (e.g., time offsets and/or the LP-WUS offsets etc. in terms of the slots, the symbols, the frames, and/or ms etc.) for the LP-WUS MOs and/or the LOs with respect to the PDCCH MOs. In an example, the WTRU may receive the first LP-WUS offset, the second LP-WUS offset with respect to the locations of PDCCH MOs (e.g., the starting position (e.g., the symbol, the slot, the frame, and/or the starting time etc.) of the PDCCH MOs etc.). The first LP-WUS offset may be associated with the first MR ramp-up time (e.g., the first LP-WUS offset is greater than or equal to the first MR ramp-up time etc.). The second LP-WUS offset may be associated with the second MR ramp-up time (e.g., the second LP-WUS offset greater than or equal to the second MR ramp-up time etc.).

The WTRU may receive the configuration information of the sets of LP-WUS MOs associated with each PDCCH MO. The set of LP-WUS MOs may include one or more LP-WUS MOs associated with two or more configured LP-WUS offsets. In an example, in case the WTRU is configured with two LP-WUS offsets (e.g., the first LP-WUS offset and the second LP-WUS offset), the WTRU may be configured with the first LP-WUS MO and/or the first LP-WUS offset prior to each PDCCH MO. The WTRU may be configured with the second LP-WUS MO and/or the second LP-WUS offset prior to each PDCCH MO.

The WTRU may receive the configuration information of the sets of LOs associated with each PDCCH MO. The set of LOs may include one or more LOs associated with two or more configured LP-WUS offsets. In an example, in case the WTRU is configured with two LP-WUS offsets (e.g., the first LP-WUS offset and the second LP-WUS offset), the WTRU may be configured with the first LO located at the first LP-WUS offset prior to each PDCCH MO. The WTRU may be configured with the second LO located at the second LP-WUS offset prior to each PDCCH MO.

The WTRU may receive the configuration of the one or more LP-WUSs associated with each LO. In an example, the WTRU may receive the configuration of the plurality of MOs per LO where each MO may be associated with a different (e.g., DL) beam and/or a reference signal that the WTRU is configured with.

The WTRU may determine the LP-WUS MOs and/or the LOs for monitoring the LP-WUSs based on the LP-WUS offset. The WTRU may determine the one or more LP-WUS MOs and/or the LOs from the set of LP-WUS MOs and/or the set of LOs associated with each PDCCH MO based on the determined LP-WUS offset. The WTRU may monitor for and/or receive the one or more LP-WUSs via the one or more determined LP-WUS MOs and/or the one or more determined LOs.

From the set of LP-WUS MOs associated with the PDCCH MO, the WTRU may determine the one or more LP-WUS MOs for monitoring and/or receiving the LP-WUSs (e.g., prior to the PDCCH MO). In an example, if the determined LP-WUS offset is the first LP-WUS offset, the WTRU may determine the one or more LP-WUS MOs located at the first LP-WUS offset prior to the PDCCH MO out of the set of LP-WUS MOs associated with the PDCCH MO. In an example, the WTRU may determine the LP-WUS MO which is located closest to the PDCCH MO out of all the LP-WUS MOs that are located at the first LP-WUS offset prior to the PDCCH MO. In another example, if the determined LP-WUS offset is the second LP-WUS offset, the WTRU may determine the one or more LP-WUS MOs located at the second LP-WUS offset prior to the PDCCH MO out of the set of LP-WUS MOs associated with the PDCCH MO. In an example, the WTRU may determine the LP-WUS MO which is located closest to the PDCCH MO from the plurality of LP-WUS MOs that are located at the second LP-WUS offset prior to the PDCCH MO. The WTRU may monitor for and/or receive the one or more LP-WUSs in the determined LP-WUS MOs.

From the set of LOs associated with the PDCCH MO, the WTRU may determine the one or more LOs for monitoring and/or receiving the LP-WUSs. In an example, if the determined LP-WUS offset is the first LP-WUS offset, the WTRU may determine the one or more LOs located at the first LP-WUS offset prior to the PDCCH MO from the set of LOs associated with the PDCCH MO. In an example, the WTRU may determine the LO which is located closest to the PDCCH MO from the plurality of LOs that are located at the first LP-WUS offset prior to the PDCCH MO. In an example, if the determined LP-WUS offset is the second LP-WUS offset, the WTRU may determine the one or more LOs located at the second LP-WUS offset prior to the PDCCH MO from the set of LOs associated with the PDCCH MO. In an example, the WTRU may determine the LO which is located closest to the PDCCH MO from the plurality of LOs that are located at the second LP-WUS offset prior to the PDCCH MO. The WTRU may monitor for and/or receive the one or more LP-WUSs in the determined LO. In an example, the WTRU may monitor for and/or receive the one or more LP-WUS in the one or more LP-WUS MOs associated with the determined LOs.

If the WTRU receives the LP-WUS indicating to wake-up, the WTRU may monitor for and/or receive the one or more PDCCHs in the PDCCH MO associated with the LP-WUS MO and/or LO at which the WTRU receives the LP-WUS. In an example, the WTRU may monitor for and/or receive the PDCCHs in the PDCCH MO located at the determined LP-WUS offset from the reception of the LP-WUS (and/or from the MO and/or the LO that the WTRU received the LP-WUS indicating to wake-up the MR).

Based on the one or more PDCCHs received in the PDCCH MO, the WTRU may receive the one or more DL signals and/or channels (e.g., the DCI, the PDSCH, and/or the PDCCHs) and/or transmits the one or more UL signals and/or channels (e.g., the PUCCH, the PUSCH, the SRS, and/or the HARQ ACK and/or NACK etc.).

In an embodiment, the WTRU may determine to receive the PDCCHs outside the DRX active time and/or during the DRX active time.

The WTRU receives the LP-WUS (e.g., a group based LP-WUS) outside the DRX active time, determines the location (e.g. outside the DRX active time and/or during the next DRX active time) for monitoring the PDCCHs based on the one or more conditions (e.g., the battery status, the buffer status, and/or the synchronization status, etc.) and/or one or more configurations) (e.g., an indicated priority of traffic to be scheduled, a configuration associated with CSI reporting, etc.) and/or one or more WTRU capabilities etc.

The WTRU receives the one or more configurations and/or the indication, e.g., via the RRC signaling, the MAC-CE indication, the DCI indication, and/or the SI etc.

The WTRU receives the one or more configurations associated with the DRX mode of the base station and/or the cell including one or more of starting locations of the DRX cycles. The WTRU also receives the configuration information about one or more durations of the DRX cycles, e.g., the one or more timers (e.g., the on duration timer (e.g., the DRX onDuration Timer) and/or the inactivity timer etc.) associated with monitoring the one or more DL signals and/or channels (e.g., the PDCCHs and/or the DCIs etc.).

The WTRU receives the configuration information regarding the one or more timers associated with the UL re-transmissions (e.g. the DRX-retransmission-TimerUL etc.).

The WTRU receives the configuration information regarding the one or more timers associated with the DL re-transmissions (e.g. the DRX-retransmission-TimerDL etc.).

The WTRU receives the configuration information regarding the one or more timers associated with the HARQ (e.g., the DRX-HARQ-RTT-TimerUL and/or the DRX-HARQ-RTT-TimerDL etc.)

The WTRU receives the configuration information regarding the LP-WUS monitoring.

The WTRU receives the configuration information associated with the one or more LOs and the one or more LP-WUS MOs associated with each LO. In an example, the WTRU may receive the configuration (e.g., based on the one or more offsets with respect to starting resource of the DRX-onDurationTimer, the periodicity etc., received via the RRC signaling, the SI, and/or the MAC-CE indication) of the one or more LOs per DRX cycle (e.g., the C-DRX). The WTRU may receive the configuration (e.g., based on the one or more offsets with respect to the starting resources of the LOs) of one or more (K) LP-WUS MOs (e.g., the one or more resources for receiving the LP-WUS) within each LO. In case the LP-WUS is supported with multiple (N) beams, the WTRU may receive the configuration of N×K LP-WUS MOs for each LO.

The WTRU may receive the configuration information indicative of the modulation (e.g. OOK1 and/or OOK4, etc.)

The WTRU may receive the configuration information indicative of the one or more SS sets for the PDCCH monitoring outside the DRX active time.

The WTRU may receive the configuration information and/or indication indicative of enabling the PDCCH monitoring location determination based on the WTRU determination.

The WTRU may receive the one or more conditions and/or statuses of the WTRU and associated thresholds for determining the PDCCH monitoring location, for example, the battery status, one or more thresholds associated with the battery status, mobility (e.g., speed), UL buffer status, and/or synchronization status etc. for example, one or more thresholds associated to a time duration since last time-frequency synchronization (i.e. t_synchronization).

The WTRU may receive the configuration information and/or the indication including a plurality of timer sets, i.e. two or more sets of timers, for example, a first set of timers and a second set of timers etc. Each set of timers may include the one or more timers (e.g., the on duration timer, the inactivity timer, the short DRX cycle timer, the one or more timers associated with the HARQ, the one or more times associated with the re-transmissions etc.). The first set of timers may be associated with monitoring and/or receiving the PDCCHs and transmitting and/or receiving the one or more additional signals and/or channels (e.g., the PDCCHs, the PDSCHs, the PUCCHs, the PUSCHSs, the HARQ ACK, and/or the SR, etc.) during the DRX active time. The second set of timers may be associated with monitoring and/or receiving the PDCCHs and/or one or more additional signals and/or channels outside the DRX active time.

The WTRU may receive the configuration information to determine the location of PDCCH monitoring. In an example, the WTRU may receive a threshold associated with the time gap between the wake-up indication (e.g., a time at which the LP-WUS was received) and the next DRX active time. In an example, the configuration information may include the association between the location for the PDCCH monitoring and a priority (e.g. the priority is indicated via the LP-WUS) of the DL data to be scheduled.

The WTRU may determine the location for monitoring the PDCCHs based on the one or more conditions experienced by the WTRU and/or a status of the WTRU.

The WTRU may determine, receive, be configured, and/or be indicated with the one or more configuration information, for example on time and/or frequency resources and/or occasions, for monitoring the PDCCH. In an example, the WTRU may be configured and/or indicated to select from one of the configured and/or indicated PDCCH monitoring occasions and/or locations. In an example, the WTRU may receive the indications and/or configurations on the PDCCH monitoring locations and/or occasions via the RRC, the MAC-CE, and/or the DCI, etc.

In an example, the WTRU may be configured and/or indicated with the first and a second PDCCH monitoring occasions and/or locations. In an example, the first configured PDCCH monitoring occasions and/or the location may be outside of the configured and/or indicated DRX active time. In another example, the second configured PDCCH monitoring occasion and/or location may be within the next, following, and/or upcoming DRX active time.

In an example, the WTRU may determine, be configured, and/or indicated to select the location for monitoring PDCCH among one or more configured and/or determined PDCCH monitoring locations and/or occasions based on the one more conditions and/or events. In an example, the WTRU may determine the location for monitoring the PDCCH based on the one or more WTRU statuses and/or one or more configured and/or indicated threshold values. In an example, the WTRU may receive the indicated and/or configured threshold values via the RRC, the MAC-CE, and/or the DCI, etc.

For the battery status, for example, the WTRU may monitor the first configured PDCCH monitoring occasion and/or location (e.g., outside of the DRX active time), and determine if a remaining battery power is higher than or equal to a corresponding configured threshold. The WTRU may monitor the second configured PDCCH monitoring occasion and/or location (e.g., in the next DRX active time), and determine if the remaining battery power is lower than the corresponding configured threshold.

For mobility, the WTRU may monitor the first configured PDCCH monitoring occasion and/or location (e.g., outside of the DRX active time), and determine if a speed of the WTRU is lower than a corresponding configured threshold. The WTRU may monitor the second configured PDCCH monitoring occasion and/or location (e.g., in the next DRX active time), and determine if the speed of the WTRU is higher than or equal to the corresponding configured threshold.

For the UL buffer status, the WTRU may monitor the first configured PDCCH monitoring occasion and/or location (e.g., outside of the DRX active time), if the WTRU has UL data and/or control data to be transmitted. The WTRU may monitor the second configured PDCCH monitoring occasion and/or location (e.g., in the next DRX active time), if WTRU does not have the UL data and/or control data to be transmitted.

For synchronization status, for example, the WTRU may monitor the first configured PDCCH monitoring occasion and/or location (e.g., outside of the DRX active time), if the time duration since the last synchronization is higher than a corresponding configured threshold. The WTRU may monitor the second configured PDCCH monitoring occasion and/or location (e.g., in the next DRX active time), if the time duration since the last synchronization is lower than the corresponding configured threshold.

In an example, the WTRU may indicate and/or report the PDCCH monitoring locations and/or occasions where the WTRU can monitor the PDCCH, for example, as a part of the WTRU capability report. In an example, the WTRU may indicate and/or report, for example to the gNB, on whether the WTRU is capable of monitoring the PDCCH based on the first PDCCH monitoring occasions and/or locations (e.g., outside the DRX active time). The WTRU may transmit the report and/or indication as part of the UCI, the MAC-CE, and/or the RRC, etc.

The WTRU may determine the location for monitoring the PDCCHs based on the configurations and/or the WTRU capabilities.

In an example, the WTRU may receive the wake-up indication (e.g., outside the DRX active time).

Based on the wake-up indication, the WTRU may determine the location for the PDCCH monitoring (e.g., for paging occasion monitoring). In an example, the WTRU may receive the PDCCH (e.g., scheduling the PDSCH for the paging message) in the determined location for the PDCCH monitoring. The location may be one or more of the search space, the CORESET, the one or more OFDM symbols, the slots, the time window, and/or the frequency resources etc.

The determination of the location may be based on one or more conditions. In an example, the determination of the location may be based on the gNB configuration. In an example, the determination of the location may be based on the configuration of the C-DRX, for example, if both long and short C-DRX are configured to the WTRU, the WTRU may determine to monitor the PDCCH in the first location (e.g., the next DRX active time). If only the long C-DRX is configured to the WTRU, the WTRU may monitor the PDDCH in the second location (e.g., outside the DRX active time).

In an example, the determination of the location may be based on the configuration for CSI and/or L1-RSRP reports. In an example, if the WTRU is configured with the CSI reporting configurations (e.g., periodic and/or semi-static) during the DRX active time, the WTRU may determine to monitor the PDCCH in the first location (e.g., the next DRX active time). If the WTRU is not configured with CSI reporting configurations during the DRX active time, the WTRU may determine to monitor the PDCCH outside the DRX active time.

In an example, the determination of the location may be based on the gNB indication, for example, via one or more of the RRC, the MAC CE, the DCI and/or the LP-WUS etc. The gNB indication may be a priority indication. In an example, the WTRU may receive the priority indication (e.g., via the LP-WUS). If the indication indicates a first priority (e.g., a low priority), the WTRU may determine to monitor the PDCCH in the first location (e.g., the next DRX active time). If the indication indicates the second priority (e.g., high priority), the WTRU may determine to monitor the PDCCH in a second location (e.g., outside the DRX active time).

The WTRU may monitor and/or receive PDCCHs at the determined location. In an example, the WTRU may select the set of timers from the configured two or more sets of timers based on the determined location for monitoring and/or receiving the PDCCHs. While the one or more timers associated with the determined set of timers are running, the WTRU may monitor for and/or receive the PDCCHs. In an example, the WTRU may determine the set of timers from the configured two or more set of timers based on the determined location for the PDCCH monitoring. In an example, the WTRU may select the first set of timers for monitoring and/or receiving the PDCCHs if the determined location for the PDCCH monitoring is during the DRX active time. The WTRU may select the second set of timers for monitoring and/or receiving the PDCCHs if the determined location for the PDCCH monitoring is outside the DRX active time.

The WTRU starts the one or more timers associated with the PDCCH monitoring from the determined set of timers. In an example, the WTRU may start the on duration timer associated with the first set of timers in case the WTRU selects the first set of timers (selected to monitor for the PDCCHs outside the DRX active time). While the timer is running, the WTRU may monitor for and/or receive the PDCCHs. In an example, the WTRU may start the on duration timer associated with the second set of timers in case the WTRU selects the second set of timers (e.g., selected to monitor for the PDCCHs outside the DRX active time). While the timer is running, the WTRU may monitor for and/or receive the PDCCHs. Based on the one or more PDCCHs received, the WTRU may receive and/or transmit the one or more signals and/or channels (e.g., the PDSCHs, the PUCCHs, the SRS, and/or the PUSCHs etc.).

The WTRU may determine the HARQ ACK and/or retransmissions related to the procedures based on the location of the PDCCH monitoring. In an example, the WTRU may determine to (or not to) transmit the ACK and/or the NACK, for the received DL data (e.g., the PDCCHs and/or the PDSCHs) based on the one or more conditions related to the retransmission operations. In an example, the WTRU may be configured and/or indicated the one or more conditions from base station via the RRC message and/or the MAC CE and/or the DCI indication. In an example, the WTRU may determine to transmit the ACK and/or the NACK for the received one or more DL data associated and/or indicated with PDDCH monitoring being within the DRX active time. In an example, the WTRU may determine to skip transmit (or not transmit) the ACK and/or the NACK for the one or more DL data associated and/or indicated with the PDDCH monitoring being outside of the DRX active time.

In an example, the WTRU may transmit and/or report one or more bundled, collected, and/or accumulated ACKs and/or NACKs (e.g., using the resource in the next DRX active time) in a single report associated with the DL data in the next DRX active time. In an example, the WTRU may bundle, collect ACK and/or NACK, for the one or more DL associated and/or indicated with the PDCCH monitoring being outside of the DRX active time and/or the next DRX active time.

In an example, the WTRU may determine the DL retransmissions for the received one or more DL data based one the location of the PDDCH monitoring and/or the one or more conditions related to the retransmission operation. In an example, the WTRU may be configured with one or more threshold values (e.g., the time gap) from the base station via the RRC message and/or the MAC CE.

In an example, the WTRU may scale and/or skip to run one or more timers (e.g., the DRX-HARQ-RTT-TimerDL and/or the DRX-retransmissionTimerDL etc.) for one or more DL data associated and/or indicated with the PDCCH monitoring outside of the DRX active time. In an example, the WTRU may scale the DL timer values related retransmission (e.g., the DRX-HARQ-RTT-TimerDL and/or the DRX-retransmissionTimerDL) if the time gap between PUCCH carrying NACK and/or starting position of the next DRX active time is smaller than the configured threshold value. In an example, the WTRU may not scale the DL timer values related retransmission (e.g., the DRX-HARQ-RTT-TimerDL and/or the DRX-retransmission TimerDL etc.) if the time gap between the PUCCH carrying the NACK and the starting position of the next DRX active time is larger than the configured threshold value.

In an example, the WTRU may perform the DL retransmissions with scaled timer values for the received one or more DL data. In an example, the WTRU may run related retransmission timers (e.g., the DRX-HARQ-RTT-TimerDL and/or the DRX-retransmission TimerDL etc.) with the scaled timer values.

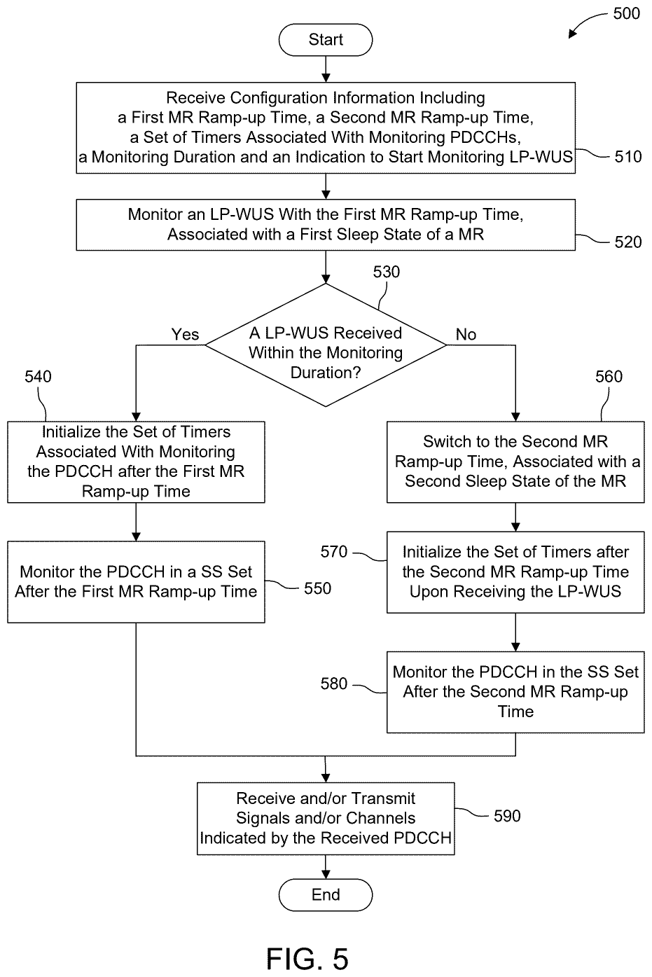

FIG. 5 is a flowchart illustrating an example process 500 of monitoring multiple SS sets according to an embodiment. The process 500 may be performed by the WTRU. At 510, the WTRU may receive the configuration information including the first and second MR ramp-up times, the set of timers associated with monitoring the PDCCH, the monitoring duration, and/or the indication to start the monitoring of the LP-WUS. The WTRU may include the transceiver configured to receive the configuration information.

At 520, the WTRU may monitor for the LP-WUS with the first MR ramp-up time, which is associated with the first sleep state of the MR. The WTRU may include the processor configured to monitor the LP-WUS using the LP-WUR with the first MR ramp-up time.

At 530, the WTRU checks whether the LP-WUS is received within the monitoring duration. The configuration information includes the LP-WUS monitoring duration and/or the LP-WUS counter configuration. The WTRU measures the time elapsed after the start or the resumption of monitoring the LP-WUS. The WTRU compares the measured time with the LP-WUS monitoring duration. The WTRU determines that the LP-WUS is received within the threshold time period if the measured time is less than the LP-WUS monitoring duration. The WTRU initializes the LP-WUS counter to count the number of LP-WUS MOs occurring after the start of monitoring the LP-WUS. The WTRU compares the number of LP-WUS MOs indicated by the LP-WUS counter with the threshold counter value indicated by the LP-WUS counter configuration. The WTRU determines that the LP-WUS is received within the threshold time period if the number of MOs is less than when the threshold counter value.

If the LP-WUS is received before the threshold time period, at 540, the WTRU may initialize the set of timers after the first MR ramp-up time.

At 550, the WTRU monitors the PDCCH in the first SS set based on the set of timers after the first MR ramp-up time.

If the LP-WUS is not received within the monitoring duration, at 560, the WTRU switches to the second MR ramp-up time, which is associated with the second sleep state of the MR. The first MR ramp-up time is associated with the light sleep state (e.g. the first sleep state) of the MR and/or the WTRU. The second MR ramp-up time is associated with the deep sleep state (e.g. the second sleep state) of the MR and/or the WTRU.

At 570, the WTRU initializes the set of timers after the second MR ramp-up time upon receiving the LP-WUS.

At 580, the WTRU monitors the PDCCH in the second SS set after the second MR ramp-up time.

At 590, the WTRU receives and/or transmits the signals and/or channels indicated by the PDCCH.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method performed by a wireless transmit/receive unit (WTRU), the method comprising:
receiving, from a base station, configuration information including one or more of: a first main radio receiver (MR) ramp-up time, a second MR ramp-up time, or a set of timers associated with monitoring a physical downlink control channel (PDCCH);
starting a monitoring duration;
activating a low power wake-up receiver (LP-WUR);
receiving a low-power wake-up signal (LP-WUS) using the LP-WUR;
on a condition that the LP-WUS is received within the monitoring duration, monitoring for, after the first MR ramp-up time, a PDCCH transmission using the MR based on the set of timers; and
on a condition that the LP-WUS is received after the monitoring duration, monitoring for, after the second MR ramp-up time, the PDCCH transmission using the MR based on the set of timers.

2. The method of claim 1, wherein the first MR ramp-up time is associated with a first sleep state of the MR and the second MR ramp-up time is associated with a second sleep state of the MR.

3. The method of claim 2, wherein the MR switches from the first sleep state to the second sleep state when the monitoring duration is exceeded.

4. The method of claim 1, further comprising:
initializing the set of timers after the first MR ramp-up time when the LP-WUS is received within the monitoring duration.

5. The method of claim 1, further comprising:
initializing the set of timers after the second MR ramp-up time when the LP-WUS is received after the monitoring duration.

6. The method of claim 1, wherein the configuration information further includes one or more of: an LP-WUS search space (SS) set, a first SS set associated with the first MR ramp-up time, or a second SS set associated with the second MR ramp-up time.

7. The method of claim 6, further comprising:
monitoring the PDCCH using the LP-WUS SS set upon receiving an indication via the LP-WUS.

8. The method of claim 6, further comprising:
monitoring the PDCCH using the first SS set when the LP-WUS is received within the monitoring duration.

9. The method of claim 6, further comprising:
monitoring the PDCCH using the second SS set when the LP-WUS is received after the monitoring duration.

10. The method of claim 1, further comprising:
measuring a time elapsed after a start or a resumption of monitoring the LP-WUS;
comparing the measured time with the monitoring duration; and
determining that the LP-WUS is received within the monitoring duration if the measured time is less than the monitoring duration.

11. The method of claim 1, wherein the configuration information further includes an LP-WUS counter configuration.

12. The method of claim 11, further comprising:
initializing an LP-WUS counter for counting a number of LP-WUS monitoring occasions (MOs) occurring after a start or a resumption of monitoring the LP-WUS;
comparing the number of LP-WUS MOs indicated by the LP-WUS counter with a threshold counter value indicated by the LP-WUS counter configuration; and
determining that the LP-WUS is received within the monitoring duration if the number of LP-WUS MOs is less than the threshold counter value.

13. A wireless transmit/receive unit (WTRU), comprising:
a memory;
a main radio receiver (MR);
a low-power wake-up radio receiver (LP-WUR);
a transceiver configured to receive, from a base station, configuration information including one or more of: a first MR ramp-up time, a second MR ramp-up time, and a set of timers associated with monitoring a physical downlink control channel (PDCCH); and
a processor configured to:
start a monitoring duration,
activate a low power wake-up receiver (LP-WUR),
receive a low-power wake-up signal (LP-WUS) using the LP-WUR,
on a condition that the LP-WUS is received within the monitoring duration,
monitor for, after the first MR ramp-up time, a PDCCH transmission using the MR based on the set of timers, and on a condition that the LP-WUS is received after the monitoring duration,
monitor for, after the second MR ramp-up time, the PDCCH transmission using the MR based on the set of timers.

14. The WTRU of claim 13, wherein the first MR ramp-up time is associated with a first sleep state of the MR and the second MR ramp-up time is associated with a second sleep state of the MR, and wherein the MR switches from the first sleep state to the second sleep state when the monitoring duration is exceeded.

15. The WTRU of claim 13, wherein the processor is further configured to:
initialize the set of timers after the first MR ramp-up time when the LP-WUS is received within the monitoring duration.

16. The WTRU of claim 13, wherein the processor is further configured to:
initialize the set of timers after the second MR ramp-up time when the LP-WUS is received after the monitoring duration.

17. The WTRU of claim 13, wherein the configuration information further includes one or more of: an LP-WUS search space (SS) set, a first SS set associated with a first MR ramp-up time, or a second SS set associated with a second MR ramp-up time.

18. The WTRU of claim 17, wherein the processor is further configured to:
monitor the PDCCH using the LP-WUS SS upon receiving an indication via the LP-WUS.

19. The WTRU of claim 17, wherein the processor is further configured to:
monitor the PDCCH using the first SS set when the LP-WUS is received within the monitoring duration.

20. The WTRU of claim 17, wherein the processor is further configured to:
monitor the PDCCH using the second SS set when the LP-WUS is received after the monitoring duration.
